(19) United States
(12) Patent Application Publication
(10) Pub. No.: US 2024/0094429 A1
(43) Pub. Date: Mar. 21, 2024

(54) SYSTEMS AND METHODS FOR PROXIMITY DETECTION AND INTERPRETATION OF NEAR PARALLEL CASED WELLS

(71) Applicant: Schlumberger Technology Corporation, Sugar Land, TX (US)

(72) Inventors: Yong-Hua Chen, Belmont, MA (US); Saad Omar, Somerville, MA (US); Michael Thiel, Watertown, MA (US); Lin Liang, Belmont, MA (US)

(21) Appl. No.: 18/468,942

(22) Filed: Sep. 18, 2023

Related U.S. Application Data
(60) Provisional application No. 63/375,863, filed on Sep. 16, 2022.

(51) Int. Cl. G01V 3/20; E21B 47/024; E21B 49/00

(52) U.S. Cl. CPC G01V 3/20; E21B 47/024; E21B 49/00

(57) ABSTRACT

A ranging workflow to interpret the ultradeep harmonic anisotropic attenuation (UHAA) measurements and estimate the distance and orientation of the existing cased well from the well being drilled is presented herein. The ranging workflow applies to scenarios in which the wells are near parallel to each other and performs reasonably well in boreholes which are more or less perpendicular to the formation layers. The ranging workflow generally includes deploying a deep directional resistivity (DDR) tool into a new wellbore; collecting UHAA data via the DDR tool; determining resistivity values based at least in part on the UHAA data; and determining a distance of the DDR tool from a casing of an existing wellbore proximate the new wellbore based at least in part on the resistivity values and a UHAA response table for the DDR tool.

### CROSS-REFERENCE TO RELATED APPLICATION

This application claims priority to and the benefit of U.S. Provisional Patent Application No. 63/375,863, entitled “A Method for the Proximity Detection and Interpretation of Near Parallel Cased Wels,” filed Sep. 16, 2022, which is hereby incorporated by reference in its entirety for all purposes.

### BACKGROUND

The present disclosure generally relates to the detection and the distance and orientation interpretation of an existing cased well from a new well being drilled with a logging while drilling (LWD) electromagnetic measurement tool with multi-component magnetic dipole transmitters and receivers in subsurface earth formations.

Ultradeep harmonic anisotropic attenuation (UHAA) measurements based on a ratio of second harmonic coupling voltages between transversely polarized magnetic dipoles of deep directional resistivity (DDR) tools have been shown to indicate the proximity of existing cased wells. A ranging workflow to interpret the UHAA measurements and estimate the distance and orientation of an existing cased well from the well being drilled may be generated. The ranging workflow applies to scenarios in which the wells are near parallel to each other and performs reasonably well in boreholes that are more or less perpendicular to the formation layers. However, UHAA measurements are also affected by formation layers. This effect increases with the inclination of the well being drilled and reaches its maximum strength when the well is horizontal at 90-degree inclination and parallel to the formation layers. As a result, the formation layers significantly interfere and limit the detection of the cased wells by the UHAA measurements in near parallel horizontal wells.

Multilateral horizontal wells are widely deployed in the field development for oil and gas reserves. As new wells are being drilled, the drillers generally want to stay away from existing wells and avoid drilling into them. In the scenarios of relief wells and well plugs and abandonments, the objective is to drill into an existing well and stop its fluid flow in the borehole. In the case of the steam-assisted gravity drainage for producing heavy crude oil and bitumen involving an advanced form of steam stimulation, drillers generally want to drill the steam-injection well in proximity of and parallel to the producing well. In all these different situations, the technologies for the detection and the distance and orientation interpretation of an existing cased well from the well being drilled are desired.

### SUMMARY

A summary of certain embodiments described herein is set forth below. It should be understood that these aspects are presented merely to provide the reader with a brief summary of these certain embodiments and that these aspects are not intended to limit the scope of this disclosure.

Certain embodiments of the present disclosure include a method that includes deploying a deep directional resistivity (DDR) tool into a new wellbore. The method also includes collecting ultradeep harmonic anisotropic attenuation (UHAA) data via the DDR tool. The method further includes determining resistivity values based at least in part on the UHAA data. In addition, the method includes determining a distance of the DDR tool from a casing of an existing wellbore proximate the new wellbore based at least in part on the resistivity values and a UHAA response table for the DDR tool.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### BRIEF DESCRIPTION OF THE FIGURES

Certain embodiments, features, aspects, and advantages of the disclosure will hereafter be described with reference to the accompanying drawings, wherein like reference numerals denote like elements. It should be understood that the accompanying figures illustrate the various implementations described herein and are not meant to limit the scope of various technologies described herein.

FIG. 1 illustrates a drilling rig and drill string for which measurements may be collected, in accordance with embodiments of the present disclosure;

FIG. 2 illustrates a representation of an embodiment of a casing detection method based on second harmonic coupling voltages between transversely polarized magnetic dipoles of deep directional resistivity (DDR) tools in near parallel wells, in accordance with embodiments of the present disclosure;

FIG. 3 illustrates a simulated ultradeep harmonic anisotropic attenuation (UHAA) channel response of a typical DDR tool as a function of the tool-to-casing distance in formations of different resistivity for a transmitter-receiver spacing of 100 feet at a frequency F2, in accordance with embodiments of the present disclosure;

FIG. 4 illustrates a casing distance interpretation workflow for near parallel vertical wells, in accordance with embodiments of the present disclosure;

FIG. 5 illustrates a synthetic data test of the casing distance interpretation workflow for near parallel vertical wells of FIG. 4, where a DDR tool is represented by a transmitter (T) and a receiver (R) in a well moving sideways so its distance to the casing (DX) varies, in accordance with embodiments of the present disclosure;

FIG. 6 illustrates example numerical test results of the casing distance interpretation workflow: (a) formation layers used in the test; (b) simulated DDR tool response (UHAA) as they vary with the casing distances (DX) for different frequencies; (c) estimated casing distances by the casing distance interpretation workflow of FIG. 4 as compared with true distance; (d) percentage error of the estimated distance; and (e) detected orientation trails of the casing location as seen from the DDR tool, in accordance with embodiments of the present disclosure;

FIG. 7 illustrates examples of processed results of an experimental dataset acquired from a field test for ranging: (a) formation apparent resistivity measured from a shallow resistivity tool; (b) UHAA data acquired with a DDR tool transmitter-receiver spacing of about 40 feet; (c) processed casing distances with the casing distance interpretation workflow of FIG. 4 are validated with the true distance obtained from the well survey data of the borehole trajectories; and (d) detected orientation trails of the casing location as seen from the DDR tool, where the ambiguity of the casing orientation may be resolved by associating the variation of the UHAA measurement with the well trajectory survey, in accordance with embodiments of the present disclosure;

FIG. 8 illustrates examples of processed results of an experimental dataset acquired from a field test for ranging: (a) formation apparent resistivity measured from a shallow resistivity tool; (b) UHAA data acquired with a DDR tool transmitter-receiver spacing of about 80 feet; (c) processed casing distances with the casing distance interpretation workflow of FIG. 4 are validated with the true distance obtained from the well survey data of the borehole trajectories; and (d) detected orientation trails of the casing location as seen from the DDR tool, in accordance with embodiments of the present disclosure;

FIG. 9 illustrates that the casing distance interpretation workflow of FIG. 4 is significantly affected by formation layers in horizontal wells: (a) formation layers used in the test; (b) simulated UHAA logs at the tool operating frequencies F1, F2, F3, and F4 as the DDR tool is being moved laterally in the true vertical depth (TVD) direction across the formation layers while maintaining a constant true horizontal length (THL) offset of three meters from the cased well; (c) estimated casing distances at the tool operating frequencies F1, F2, and F3 by the ranging workflow as compared with true distance; (d) percentage error of the estimated distance; and (e) detected orientation trails of the casing location as seen from the DDR tool, in accordance with embodiments of the present disclosure;

FIG. 10 illustrates an example method to remove the effect of formation layers from DDR tool measurements, in accordance with embodiments of the present disclosure;

FIG. 11 illustrates improved casing distance interpretation after the removal of response of the formation layers from data: (a) formation layers used in the test; (b) corrected UHAA logs after the removal of response of the formation layers; (c) estimated casing distances by the ranging workflow from the corrected UHAA logs as compared with true distance; (d) percentage error of the estimated distance; and (e) detected orientation trails of the casing location as seen from the DDR tool, in accordance with embodiments of the present disclosure;

FIG. 12 illustrates that the casing distance interpretation workflow of FIG. 4 is significantly affected by formation layers in horizontal wells: (a) formation layers used in the test; (b) simulated UHAA logs as the DDR tool is being moved laterally in the THL direction in parallel to formation layers while maintaining a constant TVD offset of three meters from the cased well; (c) estimated casing distances by the ranging workflow as compared with true distance; (d) percentage error of the estimated distance; and (e) detected orientation trails of the casing location as seen from the DDR tool, in accordance with embodiments of the present disclosure; and

FIG. 13 illustrates improved distance interpretation after the removal of the response of the formation layers from data: (a) formation layers used in the test; (b) corrected UHAA logs after the removal of the response of the formation layers; (c) estimated casing distances by the ranging workflow from the corrected UHAA logs as compared with true distance; (d) percentage error of the estimated distance; and (e) detected orientation trails of the casing location as seen from the DDR tool, in accordance with embodiments of the present disclosure.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements. Commonly, these terms relate to a reference point at the surface from which drilling operations are initiated as being the top point and the total depth being the lowest point, wherein the well (e.g., wellbore, borehole) is vertical, horizontal or slanted relative to the surface.

In addition, as used herein, the terms “real time”, “real-time”, or “substantially real time” may be used interchangeably and are intended to described operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic” and “automated” are intended to describe operations that are performed are caused to be performed, for example, by a control system (i.e., solely by the control system, without human intervention).

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments, the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 10 degrees, 5 degrees, 3 degrees, 1 degree, or 0.1 degree.

U.S. Pat. No. 10,267,945, entitled “Use of Transverse Antenna Measurements for Casing and Pipe Detection” is hereby incorporated by reference in its entirety.

Systems and methods to interpret ultradeep harmonic anisotropic attenuation (UHAA) measurement data and estimate the distance to a cased well are disclosed herein. Also disclosed herein is one or more methods to correct the UHAA measurement data and significantly improve the detection distance of the cased well by subtracting a simulated UHAA tool response in formation layers without the cased well. The profile of the formation layers may be assumed to be known or roughly known since there is already a near parallel cased well. These formation layers may be reconstructed from measurement channels of a shallow resistivity measurement tool operating at much higher frequencies with a much shorter transmitter-receiver spacing. Such a shallow tool is preferably placed as close as possible to the drilling bit so that the entire formation profiles for a deep directional resistivity (DDR) tool can be inverted in substantially real time while drilling with data acquired by the shallow tool.

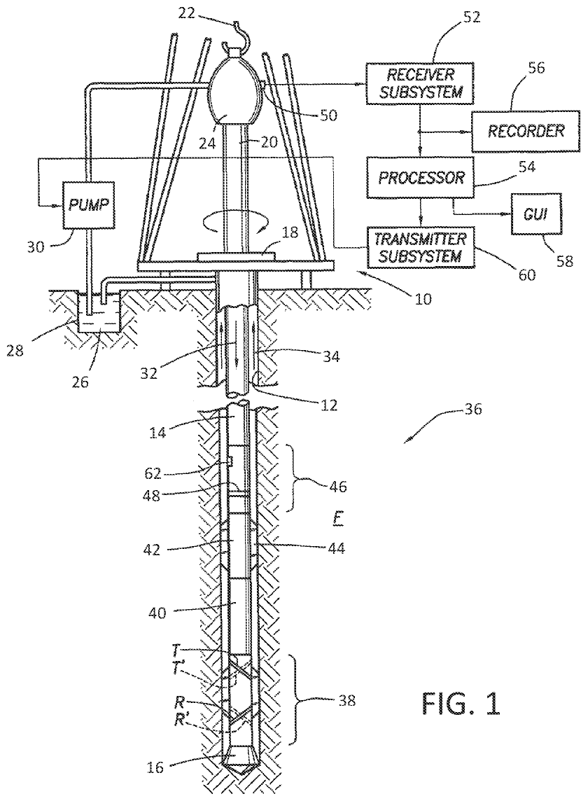

The use of the DDR measurement and boundary detection type tools that employ magnetic dipole transmitters and receivers based on differently orientated electric coils is disclosed herein. FIG. 1 illustrates a drilling rig and drill string for which measurements may be collected, as described in greater detail herein. As illustrated, a land-based platform and derrick assembly 10 are positioned over a wellbore 12 drilled through subsurface formations F. In the illustrated example, the wellbore 12 is formed by rotary drilling. Those skilled in the art will appreciate, however, that the embodiments described herein may be used in directional drilling applications using hydraulically operated drill motors as well as rotary drilling. Furthermore, use of the embodiments described herein is not limited to use on land-based rigs.

As illustrated, a drill string 14 may be suspended within the wellbore 12 and includes a drill bit 16 at its lower end. The drill string 14 may be rotated by a rotary table 18, energized by means not shown, which engages a kelly 20 at the upper end of the drill string. The drill string 14 may be suspended from a hook 22, attached to a traveling block (also not shown), through the kelly 20 and a rotary swivel 24 which permits rotation of the drill string relative to the hook 22.

Drilling fluid or mud 26 may be stored in a pit 28 formed at the well site. A pump 30 may deliver the drilling fluid 26 to an interior of the drill string 14 via a port in the swivel 24, inducing the drilling fluid to flow downwardly through the drill string 14 as indicated by the directional arrow 32. The drilling fluid 26 may exit the drill string 14 via ports in the drill bit 16, and then circulate upwardly through a region between the outside of the drill string 14 and an inner wall of the wellbore 12, called the annulus, as indicated by the direction arrows 34. In this manner, the drilling fluid 26 may lubricate the drill bit 16 and carry formation cuttings up to the surface as it is returned to the pit 28 for recirculation.

The drill string 14 also includes a bottomhole assembly (“BHA”) 36 near the drill bit 16 (typically within several drill collar lengths from the drill bit 16). The bottomhole assembly 36 may include capabilities for measuring, processing, and storing information, as well as communicating with the surface. The BHA 36 may include, among other things, a measuring and local communications apparatus 38 for determining and communicating the resistivity of the formation F surrounding the wellbore 12. The communications apparatus 38, which may include an azimuthally sensitive resistivity measuring instrument, may include a first pair of transmitting/receiving antennas T, R, as well as a second pair of transmitting/receiving antennas T′, R′. The second pair of antennas T′, R′ may be symmetric with respect to the first pair of antennas T, R. The resistivity instrument 38 may include a controller to control the acquisition of data, as described in greater detail herein.

The BHA 36 may also include instruments housed within drill collars 40, 42 for performing various other measurement functions, such as measurement of the natural radiation, density (gamma ray or neutron), and pore pressure of the formation F. At least some of the drill collars 40, 42 may be equipped with stabilizers 44. A surface/local communications subassembly 46 may also be included in the BHA 36, just above the drill collar 42. The subassembly 46 may include a toroidal antenna 48 used for local communication with the resistivity tool 38 (although other known local-communication means may be employed to advantage), and a known type of acoustic telemetry system that communicates with a similar system (not shown) at the earth/s surface via signals carried in the drilling fluid or mud 26. Thus, the telemetry system in the subassembly 46 may include an acoustic transmitter that generates an acoustic signal in the drilling fluid (a.k.a., “mud-pulse”) that is representative of measured downhole parameters. Such telemetry, and related telemetry techniques that impart acoustic signals in the drilling fluid 26 may be generally characterized as modulating the flow of fluid 26 in the drill string 14. It will be appreciated that the resistivity tool 38 may be, or may be part of, the DDR tools described herein.

The generated acoustical signal may be received at the surface by transducers 50. The transducers 50, for example, piezoelectric transducers, may convert the received acoustical signals to electronic signals. The output of the transducers 50 may be coupled to an uphole receiving subsystem 52, which may demodulate the transmitted signals. The output of the uphole receiving subsystem 52 may then be coupled to a computer processor 54 and a recorder 56. The computer processor 54 may be used to determine the formation resistivity profile (among other things) on a “real time” basis while logging or subsequently by accessing the recorded data from the recorder 56. The computer processor 54 may be coupled to a monitor 58 that employs a graphical user interface (“GUI”) through which the measured downhole parameters and particular results derived therefrom (e.g., resistivity profiles) may be graphically presented to a user.

An uphole transmitting system 60 may also be provided for receiving input commands from the user (e.g., via the GUI in monitor 58), and may be operative to selectively interrupt the operation of the pump 30 in a manner that is detectable by transducers 62 in the subassembly 46. In this manner, there is two-way communication between the subassembly 46 and the uphole equipment (e.g., including the transducers 50, the uphole receiving subsystem 52, the computer processor 54, the recorder 56, the monitor 58, the uphole transmitting system 60, and so forth). Those skilled in the art will appreciate that alternative acoustic techniques, as well as other telemetry means (e.g., electromechanical, electromagnetic), may be employed for communication with the surface and for use as described in greater detail herein. As used herein, the transducers 50, the uphole receiving subsystem 52, the computer processor 54, the recorder 56, the monitor 58, the uphole transmitting system 60, and so forth, may be collectively referred to as a “control system” or “surface control system”.

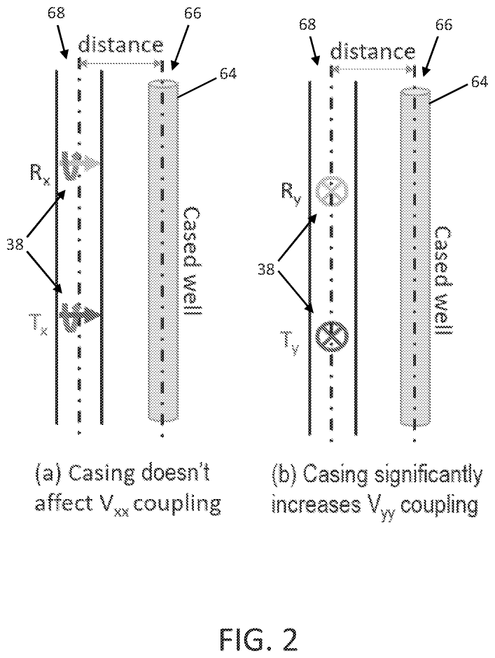

FIG. 2 illustrates a representation of an embodiment of a casing detection method based on second harmonic coupling voltages between transversely polarized magnetic dipoles of DDR tools 38 in near parallel wells. In particular, FIG. 2 explains in detail how second harmonic coupling voltages (Vₓₓ and V_{yy}) between transversely polarized magnetic dipole transmitters T and receivers R of a logging while drilling (LWD) DDR tool 38 (e.g., as part of the BHA 36 illustrated in FIG. 1) are affected by the metallic casing 64 of an existing nearby cased well 66. As a new well 68 is being drilled, the DDR tool 38 may rotate as part of the bottom hole assembly 36 on a drill string 14. FIG. 2(a) illustrates the moment when the transverse magnetic dipole transmitter T and receiver R are exactly pointing towards the cased well 66. In this case, the dipole coupling voltage Vₓₓ is virtually unaffected by the metallic casing 64 of the cased well 66 since induced eddy currents are perpendicular to the casing 64. FIG. 2(b) illustrates the alternative moment when the two transverse magnetic dipoles are 90° apart from the situation shown in FIG. 2(a). The coupling voltage is now denoted as V_{yy}, which is at its maximum value since the metallic casing 64 is now orientated along a part of the eddy current path and significantly increases the eddy current. Clearly, the ratio between Vₓₓ and V_{yy} may be used to indicate the existence of the casing 64. Coincidentally, this is how the ultradeep harmonic anisotropy attenuation channel of the DDR tool 38 is defined. The UHAA channel definition may be given as UHAA=20*log 10∥Vₓₓ/V_{yy}∥.

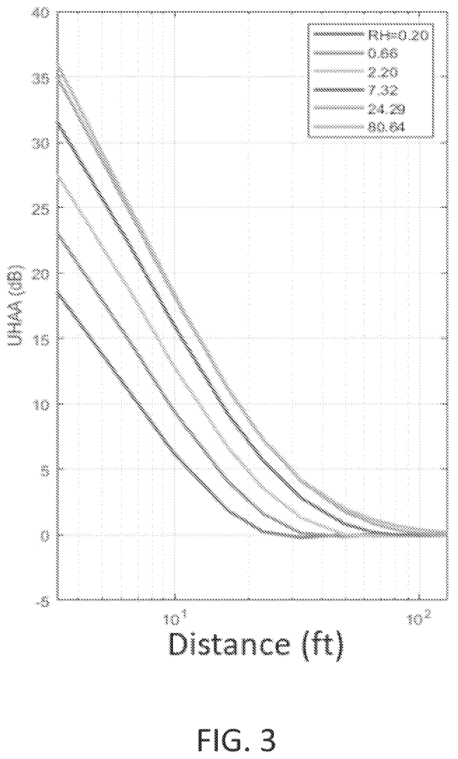

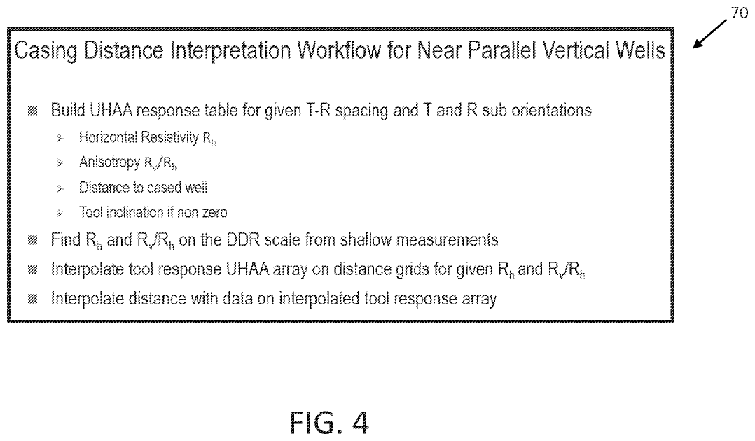

FIG. 3 illustrates a simulated UHAA channel response of a typical DDR tool 38 as a function of the tool-to-casing distance in formations of different resistivity Rₕ(Ωm) for a transmitter-receiver spacing of 100 feet at the frequency F2. FIG. 3 illustrates the simulated UHAA channel response of a typical DDR tool 38 as a function of the tool-to-casing distance in formations of different resistivity Rₕ(Ωm) for a transmitter-receiver spacing of 100 feet at the frequency F2. A homogeneous formation is assumed in this modeling. Each line plotted in FIG. 3 corresponds to a unique formation resistivity. For a given formation resistivity, one may observe that the ultradeep harmonic anisotropy attenuation, UHAA, monotonically decreases as the tool-to-casing distance increases, and the measurements of UHAA may be used to indicate and interpret the casing distance if the formation resistivity is known. Specifically, we disclose a casing distance interpretation workflow as outlined in FIG. 4.

As illustrated in FIG. 4, a casing distance interpretation workflow 70 first builds the tool response tables for given transmitter-receiver (T-R) spacings and T and R orientations, which include the UHAA response for the given DDR tool 38 configurations downhole. These tool configurations include the tool operating frequencies, the actual T-R spacings, the size of the bottom-hole assembly (BHA), and the relative orientation angles of the receiver subsections R in relation to the orientation of the transmitter subsections T. In addition to the parameters related to the tool configuration, the model parameters of the response tables may include the horizontal formation resistivity Rh, the formation resistivity anisotropy, namely, the ratio of the vertical formation resistivity (Rv) and the horizontal formation resistivity (Rh)−Rv/Rh, the distance to the cased well 66, the tool inclination angle in relation to the casing 64 of the cased well 66, and so forth.

Then, while the new well 68 is being drilled, the equivalent Rh and Rv/Rh may be calculated on the DDR tool scale from the measured data of a shallow resistivity measurement tool. These calculated equivalent Rh and Rv/Rh may then be interpolated in the previously simulated tool response tables to find their corresponding UHAA response arrays on the casing distance grids. To estimate the distance to the cased well 66, the real-time measured UHAA data may further be interpolated in this UHAA response arrays.

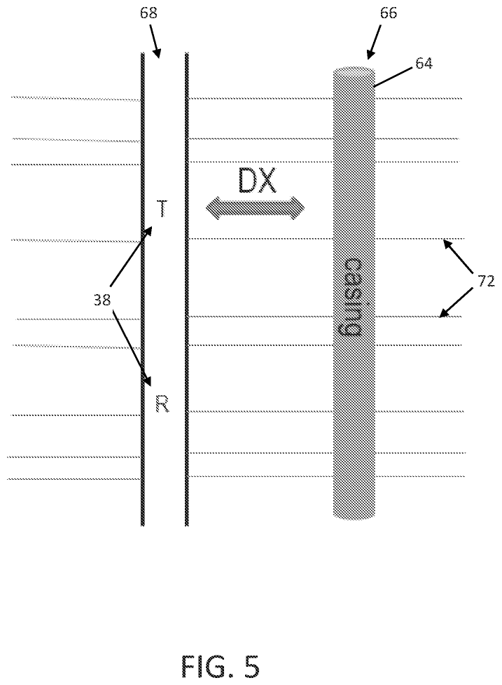

The casing distance interpretation workflow 70 illustrated in FIG. 4 was tested numerically and experimentally in the field for near parallel vertical wells as illustrated in FIG. 5. The plurality of horizontal lines 72 represent the formation layers. The well 68 being drilled contains the DDR tool 38, which is represented by the transmitter (T) and the receiver (R). In these tests, the well 68 being drilled is being moved laterally in the horizontal direction so the distance (DX) to the cased well 66 would vary.

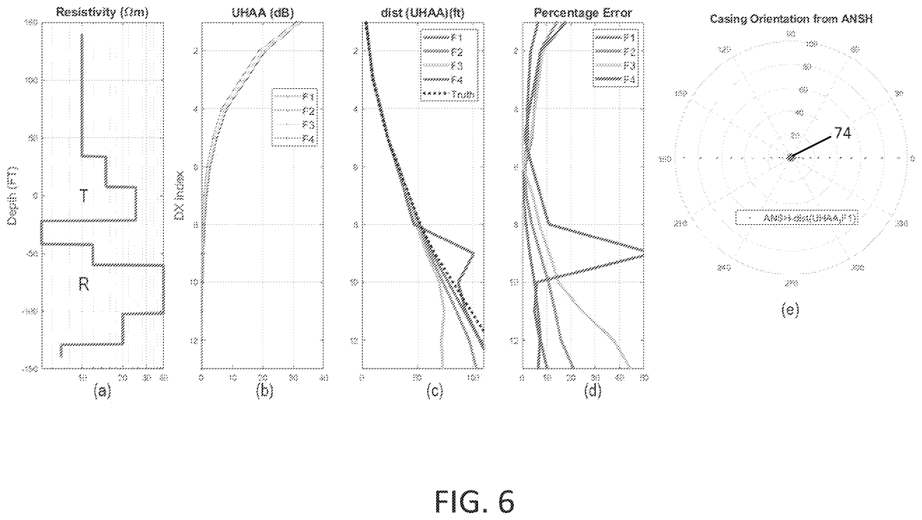

FIG. 6 illustrates numerical test results of the casing distance interpretation workflow of FIG. 4 and the ranging workflow, as described in greater detail herein. The resistivity profile of the formation layers 72 used in this numerical test is shown in FIG. 6(a). In this instance, the DDR tool 38 and the cased well 66 are parallel to each other and are both perpendicular to the formation layers 72. The transmitter-receiver (T-R) spacing of the DDR tool 38 is about 80 feet and the transmitter T is located at the zero depth. FIG. 6(b) illustrates the simulated DDR tool response (UHAA) as they vary with casing distances (DX) at several different operating frequencies F1, F2, F3, and F4. The actual simulated casing distance values may include 1, 2, 3, 5, 7, 10, 13, 16, 20, 25, 30, 35, and 40 m. The estimated casing distances by the ranging workflow are compared with true distance (DX) and are displayed in FIG. 6(c). FIG. 6(d) illustrates the percentage error of the estimated distance. As may be observed, the interpreted casing distances by the workflow agree well with the true casing distances. It is also of note that the lowest frequency at F1 performs the best.

In practice, it is note known that a new well 68 being drilled is approaching a cased well 66. Based on the results shown in FIG. 6(c), the fact that the estimated casing distances from different operating frequencies converge to a single distance value (i.e., the true casing distance) may be used to conclude that a cased well 66 is within the detection range of the DDR tool 38. Conversely, it is known that the estimated casing distances from different operating frequencies would appear inconsistent and random when there is no cased well 66 within the detection range of the DDR tool 38.

In FIG. 6(e), the estimated casing distances with the measured second harmonic angle (ANSH) is polar-plotted. The second harmonic angle is the azimuthal angle at which the UHAA response reaches its maximum. The polar plot shown in FIG. 6(e) can be used to indicate the orientation of the cased well 66 as seen by the DDR tool 38. As illustrated in FIG. 6(e), the DDR tool 38, marked by a large dot 74, sits at the center of the polar plot and sees the cased well 66 moving away laterally in either the 0° angle or the 180° angle with an implied ambiguity in the measured second harmonic angle. This ambiguity may be resolved by associating the variation of the UHAA measurement with the well trajectory survey data.

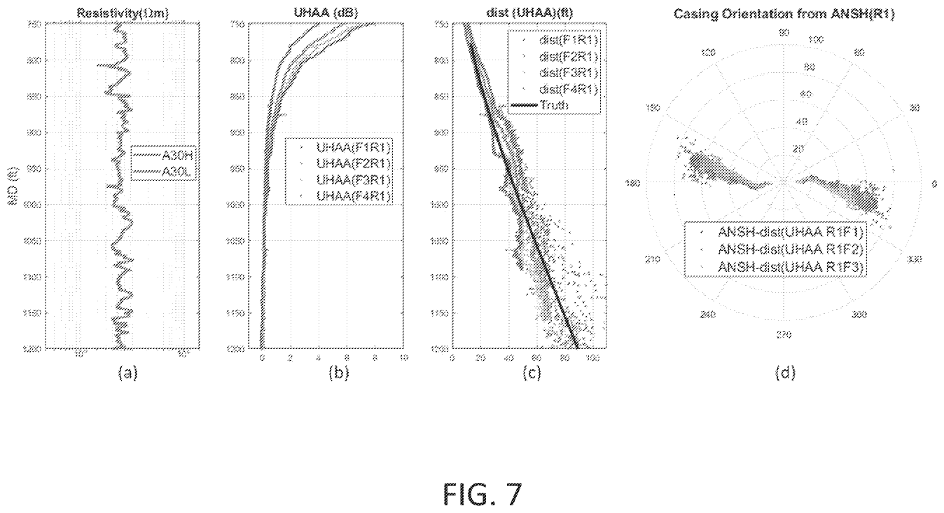

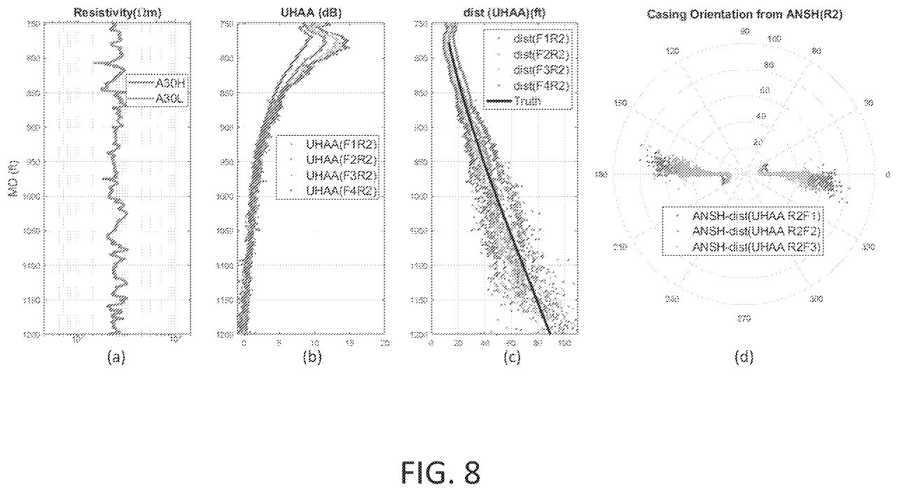

FIGS. 7 and 8 illustrate processed results of an experimental dataset acquired from a field test for the ranging application with a DDR tool 38. These two figures correspond to data measured from two separate receiver subs with different transmitter-receiver (T-R) spacings at about 40 feet and 80 feet. The formation apparent resistivity measured from a shallow resistivity tool is shown in FIGS. 7(a) and 8(a). The UHAA data acquired with the DDR tool 38 are plotted in FIGS. 7(b) and 8(b). The processed casing distances with the casing distance interpretation workflow of FIG. 4 are displayed in FIGS. 7(c) and 8(c). These processed distances agree reasonably well with the true distance obtained from the well survey data of the borehole trajectories. The polar plots of the estimated casing distances versus the measured second harmonic angle in FIGS. 7(e) and 8(e) illustrate the orientation of the cased well 66 as seen by the DDR tool 38. Again, we see two possible casing orientation trajectories. The correction solution may be easily identified by associating the variation of the UHAA measurement with the well trajectory survey data.

In summary, the casing distance interpretation workflow 70 of FIG. 4 is effective in interpreting UHAA measurement data of a DDR tool 38 to obtain a distance to a cased well 66 from a well 68 being drilled. The maximum ranging distance depends on the formation properties, the formation complexity, the DDR tool configurations such as the transmitter-receiver spacing and the operating frequencies, the measurement and modeling accuracy, and so forth. For the two given examples illustrated in FIGS. 7 and 8, the UHAA channel of the DDR tool 38, with the disclosed ranging workflow, is shown to be able to detect a casing 64 of a cased well 66 more than 50 feet away.

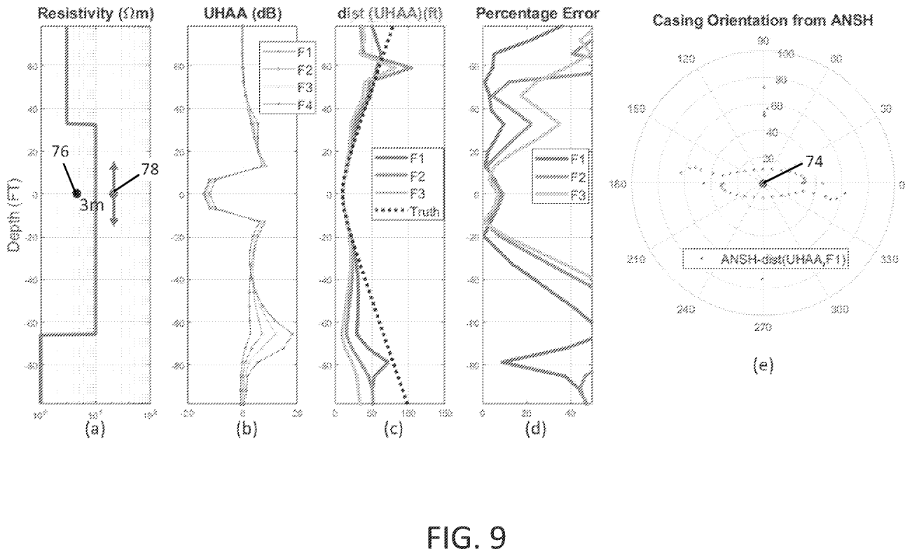

The disclosed ranging workflow applies to the scenario of near parallel vertical wells. In vertical wells, the UHAA channel of the DDR tool 38 is not significantly affected by the formation layers 72. However, the effect of the formation layers 72 on the UHAA channel increases with the inclination of the well 68 being drilled and reaches its maximum strength when the well is horizontal at a 90° inclination and parallel to the formation layers 72. FIG. 9 illustrates an example of such a horizontal well scenario in a three-layered formation. The large dots 76, 78 in FIG. 9(a) represent the cased well 66 and the new well 68 being drilled, respectively. The two horizontal wells 66, 68 are orientated perpendicularly to the paper and are in parallel with the formation layers 72. With the location of the cased well 66 always fixed at the origin, FIG. 9(b) illustrates the simulated UHAA logs at the tool operating frequencies F1, F2, F3, and F4 as the DDR tool 38 is being moved laterally (move in side-steps) in the true vertical depth (TVD) direction across the formation layers 72 while maintaining a constant true horizontal length (THL) offset of three meters from the cased well 66. As can be seen, the UHAA logs shown in FIG. 9(b) are obviously affected by the formation layers 72 with the strongest influence occurring at the boundaries of the formation layers 72. If the disclosed ranging workflow is applied directly on the UHAA logs, relatively compromised interpretation results at the tool operating frequencies F1, F2, and F3 for the casing distance as shown in FIG. 9(c) may be obtained. Acceptable interpretation results with a converging casing distance among the different operating frequencies may be produced only when the distance to the cased well 66 is under approximately 20 feet around the casing location at zero depth. In other words, the existence of the formation layers 72 significantly reduces the casing detection capability of the DDR tool 38 in horizontal wells. The DDR tool 38 may not be able to detect casings 64 farther away due to the interference of the formation layers 72.

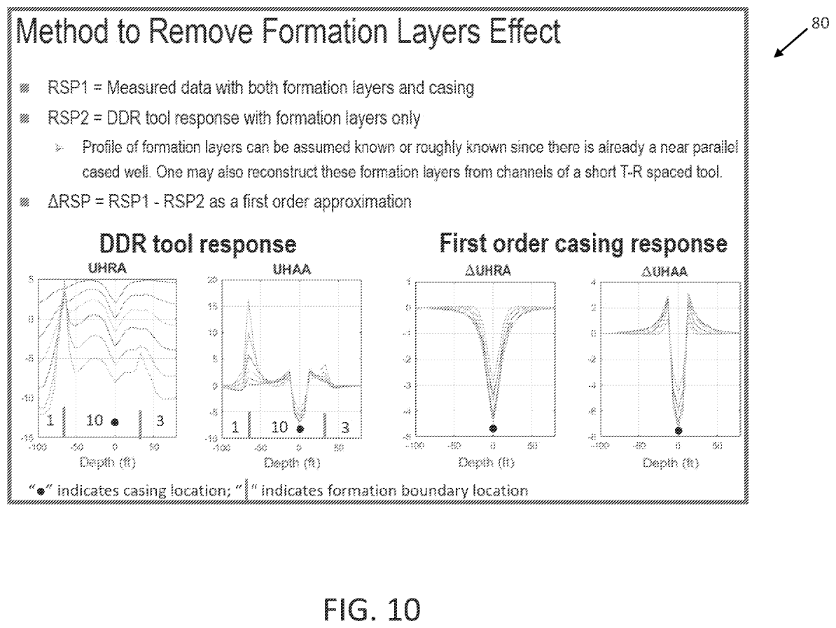

The embodiments described herein also include a method 80 to at least partially remove the interference of the formation layers 72 on the DDR measurements (RSP1) and increase the casing detection range of the DDR tool 38 in horizontal wells. For example, the DDR tool response may be calculated for the formation layers 72 only without the presence of the casing 64 (RSP2), and the formation layer response (RSP2) may be subtracted from the measured data (RSP1) (i.e., ΔRSP=RSP1−RSP2). In FIG. 10, the DDR tool response (UHRA—ultradeep harmonic resistivity attenuation, and UHAA) is illustrated before and after removal of the simulated response of the formation layers 72. It is observed that removal of the formation influence is very effective. This is likely due to the fact that the cross-field scattering between the planar formation boundary interfaces and the metallic casing line are not significant at the tool operating frequency. It is noted that the embodiments described herein generally require data relating to the formation layers 72. Such data may be readily extracted from the logging data of the existing cased well 66 to be detected or possibly from other nearby offset wells and pilot holes. A shallow formation resistivity measurement tool, preferably placed right behind the drill bit 16, may then be used to estimate the position of the wellbore 12 within the layers 72 so that the DDR tool response with respect to the layers 72 may be correctly modeled and subtracted. Alternatively, these formation layers 72 may be directly reconstructed in substantially real time from channels of the shallow formation resistivity measurement tool, which is placed preferably right behind the drill bit 16. It is noted that the measurements from a shallow resistivity tool will not be significantly affected by the cased well 66 because it uses relatively short transmitter-receiver (T-R) spacings and operates at relatively high frequencies.

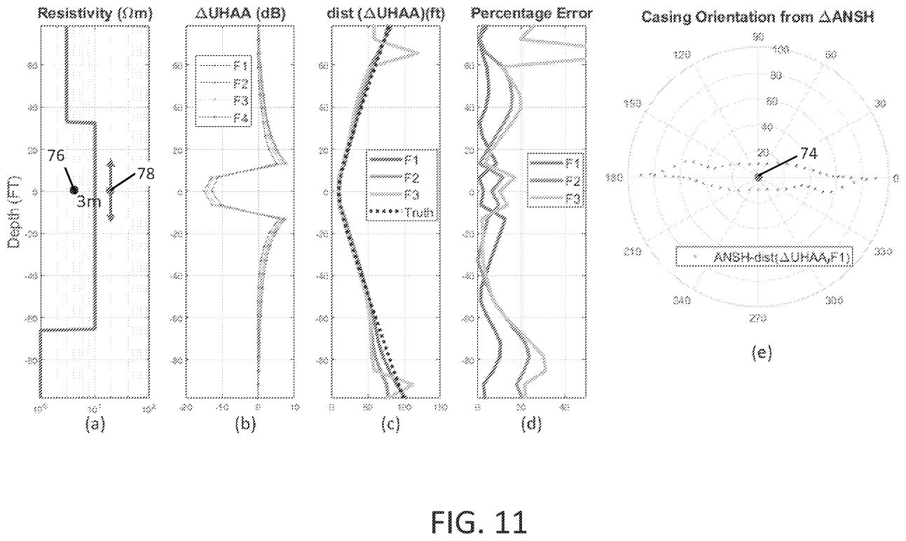

FIG. 11 illustrates results of the same example as previously illustrated in FIG. 9 except that the data used has been pre-processed by subtracting the response of the formation layers 72. If the logs illustrated in FIG. 11(b) with FIG. 9(b) are compared, it can be seen that the processed logs in FIG. 11(b) are much cleaner and free of influence from the formation layers 72. As a result, a significant increase in the interpreted detection range for the cased well 66 may be observed in FIG. 11(c) as compared to FIG. 9(c). In FIG. 11(c), consistent interpretation results in the estimated casing distances are observed for as far as 60 feet away among the three different operating frequencies.

In FIG. 11(e), the estimated casing distances are polar-plotted with the measured second harmonic angle at frequency F1. The polar plots represent the orientation of the cased well 66 as seen by the DDR tool 38. Two orientation lines for the single casing may be seen due to the nature of ambiguity in the second harmonic measurements. If FIG. 11(e) with FIG. 9(e) are compared, much longer trails for the detected casing orientation lines in FIG. 11(e) may be seen due to the relatively large increase in the ranging distance with the disclosed data interpretation method.

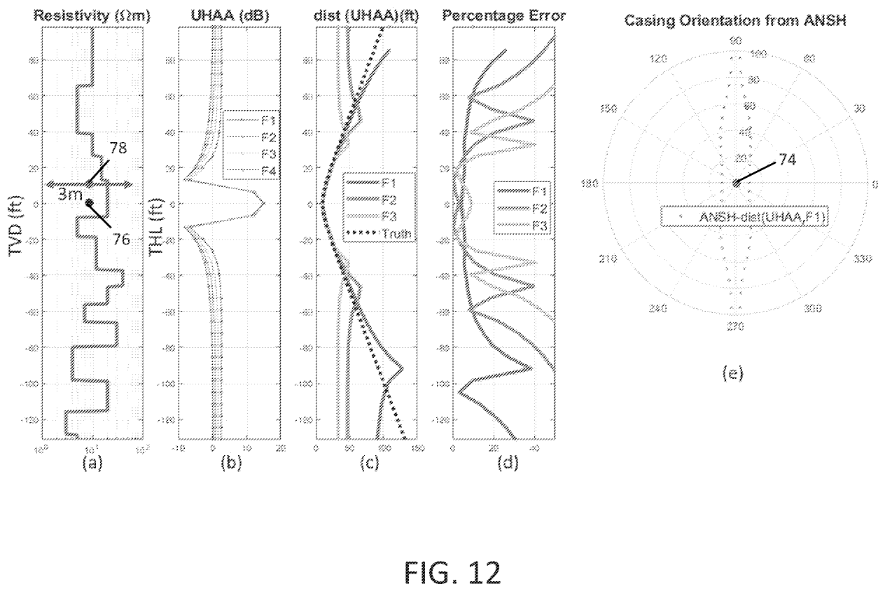

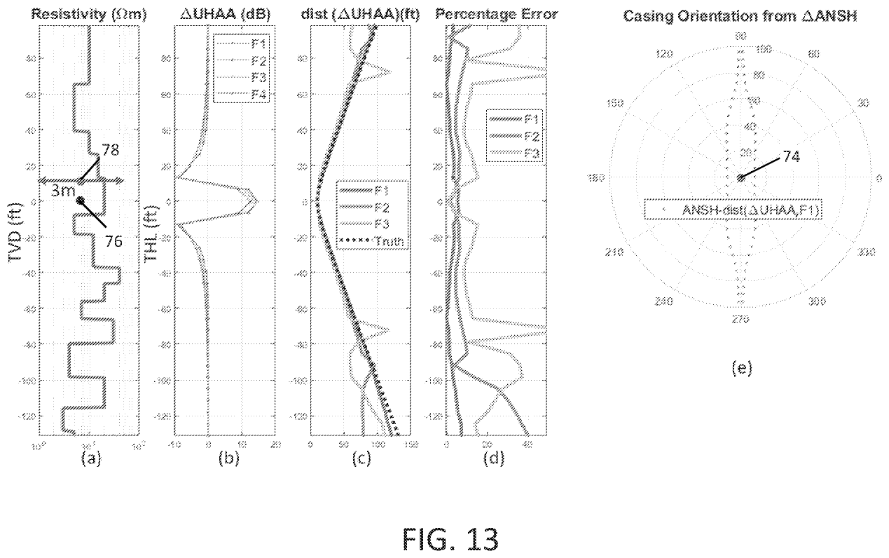

In FIGS. 9 and 11, a scenario when the DDR tool 38 side-steps in the TVD direction is presented. FIG. 12 illustrates an alternative scenario in which the DDR tool 38 moves laterally in the THL direction in parallel to the formation layers 72 while maintaining a relatively constant TVD offset of approximately three meters from the cased well 66. The UHAA logs and the processed results shown in FIG. 12 are for the case before the response of the formation layers 72 is subtracted. Again, compromised interpretation results for the casing distance may be observed as shown in FIG. 12(c) due to interference by the formation layers 72. The formation layers 72 significantly reduce the casing detection range of the DDR tool 38 in the horizontal wells. Consistent casing distances among the different operating frequencies are obtained only when the cased well 66 is nearby. According to the processed ranging results illustrated in FIG. 12(c), detection of a casing 64 may only be made for up to 25 feet away. In FIG. 13, the method 80 of FIG. 10 is applied to the ranging data by subtracting the response of the formation layers 72. The modified UHAA logs are shown in FIG. 12(b), and the newly interpreted casing distance results from the modified UHAA logs are presented in FIG. 13(c). A significantly increased ranging distance may be seen in FIG. 13(c) once the method 80 of subtracting the response of the formation layers 72 from the ranging data. The interpreted casing distances are consistent among the different operating frequencies and converge to the true distance of more than 60 feet.

It will be appreciated that the determination of the distance of the DDR tool 38 from the casing 64 of the cased well 66 may be used by the control system described herein (e.g., as illustrated in FIG. 1) to automatically adjust operational parameters of deployment of the DDR tool 38 into the new well 68. For example, in certain embodiments, the operational parameters of the deployment of the DDR tool 38 into the new well 68 that may be automatically adjusted by the control system may include, but are not limited to, a trajectory of the new well 68, a speed of the DDR tool 38 through the new well 68, or some combination thereof. As such, the control system may be configured to make sure that, if the new well 68 is getting too close to the cased well 66, the new well 68 may be slightly diverted away from the cased well 66, thereby reducing the risk of contact between the two wells 66, 68. In other embodiments, the determination of the distance of the DDR tool 38 from the casing 64 of the cased well 66 may be used by the control system to automatically alert a user (e.g., via the GUI in the monitor 58 of FIG. 1).

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. It is also contemplated that various combinations or sub-combinations of the specific features and aspects of the embodiments described may be made and still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above.

What is claimed is:

1. A method, comprising:
deploying a deep directional resistivity (DDR) tool into a new wellbore;
collecting ultradeep harmonic anisotropic attenuation (UHAA) data via the DDR tool;
determining resistivity values based at least in part on the UHAA data; and
determining a distance of the DDR tool from a casing of an existing wellbore proximate the new wellbore based at least in part on the resistivity values and a UHAA response table for the DDR tool.

2. The method of claim 1, comprising building the UHAA response table for the DDR tool based at least in part on a horizontal formation resistivity, formation resistivity anisotropy, a ratio of a vertical formation resistivity and the horizontal formation resistivity, a distance to a cased well, a tool inclination angle in relation to a casing of the cased well, or some combination thereof.

3. The method of claim 1, wherein determining the resistivity values comprises determining a horizontal formation resistivity and a ratio of a vertical formation resistivity and the horizontal formation resistivity.

4. The method of claim 3, wherein determining the distance of the DDR tool from the casing of the existing wellbore proximate the new wellbore comprises interpolating a tool response UHAA array on distance grids for a given horizontal formation resistivity and a ratio of a given vertical formation resistivity and the given horizontal formation resistivity.

5. The method of claim 1, wherein determining the distance of the DDR tool from the casing of the existing wellbore proximate the new wellbore comprises interpolating the distance with data on an interpolated tool response array.

6. The method of claim 1, wherein determining the distance of the DDR tool from the casing of the existing wellbore proximate the new wellbore comprises subtracting a DDR tool response of formation layers through which the new wellbore extends.

7. The method of claim 1, comprising automatically adjusting at least one operational parameter of deployment of the DDR tool into the new wellbore based at least in part on the distance of the DDR tool from the casing of the existing wellbore proximate the new wellbore.

8. The method of claim 7, wherein the at least one operational parameter of deployment of the DDR tool into the new wellbore comprises a trajectory of the new wellbore, a speed of the DDR tool through the new wellbore, or some combination thereof.

9. A control system, comprising:
one or more processors configured to execute processor-executable instructions, wherein the processor-executable instructions, when executed by the one or more processors, cause the control system to:
receive ultradeep harmonic anisotropic attenuation (UHAA) data collected by a deep directional resistivity (DDR) tool deployed in a new wellbore;
determine resistivity values based at least in part on the UHAA data; and
determine a distance of the DDR tool from a casing of an existing wellbore proximate the new wellbore based at least in part on the resistivity values and a UHAA response table for the DDR tool.

10. The control system of claim 9, wherein the processor-executable instructions, when executed by the one or more processors, cause the control system to build the UHAA response table for the DDR tool based at least in part on a horizontal formation resistivity, formation resistivity anisotropy, a ratio of a vertical formation resistivity and the horizontal formation resistivity, a distance to a cased well, a tool inclination angle in relation to a casing of the cased well, or some combination thereof.

11. The control system of claim 9, wherein determining the resistivity values comprises determining a horizontal formation resistivity and a ratio of a vertical formation resistivity and the horizontal formation resistivity.

12. The control system of claim 11, wherein determining the distance of the DDR tool from the casing of the existing wellbore proximate the new wellbore comprises interpolating a tool response UHAA array on distance grids for a given horizontal formation resistivity and a ratio of a given vertical formation resistivity and the given horizontal formation resistivity.

13. The control system of claim 9, wherein determining the distance of the DDR tool from the casing of the existing wellbore proximate the new wellbore comprises interpolating the distance with data on an interpolated tool response array.

14. The control system of claim 9, wherein determining the distance of the DDR tool from the casing of the existing wellbore proximate the new wellbore comprises subtracting a DDR tool response of formation layers through which the new wellbore extends.

15. The control system of claim 9, wherein the processor-executable instructions, when executed by the one or more processors, cause the control system to automatically adjust at least one operational parameter of deployment of the DDR tool into the new wellbore based at least in part on the distance of the DDR tool from the casing of the existing wellbore proximate the new wellbore, wherein the at least one operational parameter of deployment of the DDR tool into the new wellbore comprises a trajectory of the new wellbore, a speed of the DDR tool through the new wellbore, or some combination thereof.

16. A control system configured to:
build an ultradeep harmonic anisotropic attenuation (UHAA) response table for a deep directional resistivity (DDR) tool based at least in part on a horizontal formation resistivity, formation resistivity anisotropy, a ratio of a vertical formation resistivity and the horizontal formation resistivity, a distance to a cased well, a tool inclination angle in relation to a casing of the cased well, or some combination thereof;
receive ultradeep harmonic anisotropic attenuation (UHAA) data collected by the DDR tool while the DDR tool is deployed in a new wellbore;
determine resistivity values based at least in part on the UHAA data; and
determine a distance of the DDR tool from a casing of an existing wellbore proximate the new wellbore based at least in part on the resistivity values and a UHAA response table for the DDR tool.

17. The control system of claim 16, wherein determining the resistivity values comprises determining a horizontal formation resistivity and a ratio of a vertical formation resistivity and the horizontal formation resistivity.

18. The control system of claim 16, wherein determining the distance of the DDR tool from the casing of the existing wellbore proximate the new wellbore comprises interpolating a tool response UHAA array on distance grids for a given horizontal formation resistivity and a ratio of a given vertical formation resistivity and the given horizontal formation resistivity.

19. The control system of claim 16, wherein determining the distance of the DDR tool from the casing of the existing wellbore proximate the new wellbore comprises interpolating the distance with data on an interpolated tool response array.

20. The control system of claim 16, wherein determining the distance of the DDR tool from the casing of the existing wellbore proximate the new wellbore comprises subtracting a DDR tool response of formation layers through which the new wellbore extends.
